(19) United States
(12) Patent Application Publication
(10) Pub. No.: US 2026/0319760 A1
(43) Pub. Date: Oct. 15, 2026

(54) SYSTEM AND A METHOD FOR APPLICATION DEVELOPMENT

(71) Applicant: Amit JALALI, New Delhi (IN)

(72) Inventor: Amit JALALI, New Delhi (IN)

(21) Appl. No.: 19/645,913

(22) Filed: Apr. 13, 2026

(30) Foreign Application Priority Data
Apr. 15, 2025 (IN) 202511036425

(51) Int. Cl. G06F 8/34; G06F 8/36

(52) U.S. Cl. CPC G06F 8/34; G06F 8/36

(57) ABSTRACT

The present subject matter relates to a system and a method for application development. The system provides a plurality of reusable micro-components to a user, via an interactive User Interface (UI). Each micro-component comprises a plurality of user interface elements and associated functional source code. Using drag-and-drop functionality, the user selects desired micro-components through the UI. The system then integrates the functional source code of the selected micro-components to create one or more functional features of the application and displays both the selected micro-components and the integrated source code, via the UI. Additionally, the system supports low-code or no-code environments, enhancing collaboration, streamlining workflows, and making it easier to deploy applications across various platforms.

### CROSS-REFERENCE TO RELATED APPLICATIONS AND PRIORITY

The present application claims priority from Indian Patent Application no. 202511036425 filed on 15 Apr. 2025.

### FIELD OF INVENTION

The presently disclosed embodiments relate, in general, to the field of application development. More particularly, the presently disclosed embodiments are related to a system and a method for application development using a plurality of reusable micro-components.

### BACKGROUND OF THE INVENTION

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application. This summary is not intended to identify essential features of the claimed subject matter nor is it intended for use in detecting or limiting the scope of the claimed subject matter.

Contemporary software development for enterprise applications encounters several inefficiencies related to customization, deployment, and integration. These applications typically consist of various software components, such as forms, workflows, reporting tools, and administrative systems, all of which must work cohesively. Traditional development methods often involve significant manual configuration, setup, and customization, leading to longer development times and increased complexity. The components that manage user interfaces, data processing, and system integration are frequently uncoordinated, requiring developers to invest substantial effort in integrating back-end systems and configuring interfaces for specific business needs.

In conventional systems, developers are often required to build forms, workflows, or other components from scratch or heavily modify templates to make them compatible with existing tools and platforms. This approach is both time-consuming and error-prone due to the lack of standardization in UI/UX, naming conventions, and coding practices across different components. Additionally, implementing advanced features like workflow automation or data visualization typically requires custom coding, further increasing development costs and technical complexity.

Organizations today face significant challenges in rapidly deploying effective solutions to meet their evolving needs. Furthermore, earlier versions of low-code and no-code platforms often required users to have varying levels of technical knowledge, even for minor customizations. Modifying frontend components typically demanded corresponding modifications in backend systems, leading to delays and additional development work. This not only slowed down deployment but also increased the potential for errors, impacting overall reliability. The lack of standardized protocols or robust APIs further complicated the seamless integration between different components, making the software development process more time-consuming and undermining the core objective of rapid, efficient application development.

Resource constraints are also a common issue. Many organizations have limited IT staff and budgets, making it difficult to allocate sufficient resources for lengthy implementation processes. As a result, businesses often struggle to find solutions that empower non-technical users to develop and customize applications without heavy reliance on IT departments. The lack of user-friendly interfaces can further impede adoption and limit the potential of new technologies.

Moreover, as businesses scale and adapt, the need for flexibility in software solutions becomes increasingly apparent. Organizations often find themselves juggling multiple systems that do not seamlessly integrate, leading to data silos and inefficiencies. The absence of ready-to-use solutions designed with integration can result in fragmented workflows and hinder overall productivity.

Therefore, there exists a need for an improved system and method for application development to overcome at least one of the above stated disadvantages.

### SUMMARY OF THE INVENTION

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application. This summary is not intended to identify essential features of the claimed subject matter nor is it intended for use in detecting or limiting the scope of the claimed subject matter.

According to embodiments illustrated herein, a system for application development is disclosed. In one implementation of the present disclosure, the system may involve a processor and a memory. The memory is communicatively coupled to the processor. Further, the memory is configured to store one or more executable instructions that, when executed by the processor, cause the processor to provide, via an interactive User Interface (UI), a plurality of reusable micro-components to a user for development of the application. In an embodiment, each of the plurality of reusable micro-components may include a plurality of user interface elements and an associated functional source code. Further, the processor may be configured to receive, via the UI, a selection of the plurality of reusable micro-components from the user. In an embodiment, the selection being performed using a drag-drop functionality. Further, the processor may be configured to integrate the functional source code associated with each of the selected plurality of reusable micro-components to create one or more functional features associated with the application. In an embodiment, the one or more functional features being created without manual writing of additional source code. Moreover, the processor may be configured to display, via the UI, the selected plurality of reusable micro-components and the integrated functional source code.

According to embodiments illustrated herein, a method for application development is disclosed. In one implementation of the present disclosure, the method may involve various steps performed by the processor. The method may involve a step of providing, via the interactive User Interface (UI), the plurality of reusable micro-components to the user for development of the application. In an embodiment, each of the plurality of reusable micro-components may include the plurality of user interface elements and the associated functional source code. Further, the method may involve a step of receiving, via the UI, the selection of the plurality of reusable micro-components from the user. In an embodiment, the selection being performed using the drag-drop functionality. Furthermore, the method may involve a step of integrating, via the processor, the functional source code associated with each of the selected plurality of reusable micro-components to create the one or more functional features associated with the application. In an embodiment, the one or more functional features being created without the manual writing of additional source code. Moreover, the method may involve a step displaying, via the UI, the selected plurality of reusable micro-components and the integrated functional source code.

According to embodiments illustrated herein, there is provided a non-transitory computer-readable storage medium having stored thereon a set of computer-executable instructions. These instructions, when executed by the processor, may cause the processor to perform various steps. The steps may involve providing the plurality of reusable micro-components to the user for development of the application. In an embodiment, each of the plurality of reusable micro-components may include the plurality of user interface elements and the associated functional source code. Further, the steps may involve receiving the selection of the plurality of reusable micro-components from the user. In an embodiment, the selection being performed using the drag-drop functionality. Furthermore, the steps may involve integrating the functional source code associated with each of the selected plurality of reusable micro-components to create the one or more functional features associated with the application. In an embodiment, the one or more functional features being created without the manual writing of additional source code. Moreover, the steps may involve displaying the selected plurality of reusable micro-components and the integrated functional source code.

The foregoing summary is illustrative only and is not intended to be in any way limiting. In addition to the illustrative aspects, embodiments, examples, and features described above, further aspects, embodiments, and features will become apparent by reference to the drawings and the following detailed description.

### BRIEF DESCRIPTION OF DRAWINGS

The detailed description is described with reference to the accompanying figures. In the figures, same numbers are used throughout the drawings to refer like features and components. Embodiments of a present disclosure will now be described, with reference to the following diagrams below wherein:

FIG. 1 illustrates a block diagram describing a system for application development, in accordance with at least one embodiment of present subject matter.

FIG. 2 illustrates a block diagram showing an overview of various components of an application server configured for the application development, in accordance with at least one embodiment of present subject matter.

FIG. 3 illustrates a flowchart describing a method for the application development, in accordance with at least one embodiment of present subject matter.

FIG. 4 illustrates a block diagram of an exemplary computer system (401) for implementing embodiments consistent with the present subject matter, and

FIG. 5 illustrates a block diagram showing an exemplary working of the system (100) for the application development, in accordance with at least one embodiment of present subject matter.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION OF THE INVENTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are described. The disclosed embodiments are merely exemplary of the disclosure, which may be embodied in various forms.

The terminology “a plurality of reusable micro-components” and “reusable micro-components” has the same meaning and are used alternatively throughout the specification. Further, the terminology “a plurality of user interface elements”, “user interface elements”, and “UI elements” has the same meaning and are used alternatively throughout the specification. Furthermore, the terminology “reusable micro-components”, “pre-built functional components”, and “components” has the same meaning and are used alternatively throughout the specification.

The present disclosure relates to a system for application development. The primary objective of present disclosure is to enhance the efficiency and flexibility of application development by providing the system that utilizes reusable micro-components. These reusable micro-components combine user interface elements with functional source code, allowing developers to build applications more rapidly and accurately. By offering a drag-and-drop functionality within an interactive user interface (UI), the system enables developers to select and integrate micro-components without manually writing additional source code. This not only accelerates the development process but also significantly reduces the potential for errors associated with manual coding and integration.

Another key objective of the present disclosure is to facilitate platform-agnostic application development. Applications built using the disclosed system can be deployed seamlessly across various operating environments without the need for substantial modifications. This ensures that the applications maintain consistent performance and functionality regardless of the underlying platform. By eliminating platform-specific constraints, the present disclosure provides developers with the flexibility to create applications that are compatible with diverse operating systems and environments, enhancing the overall usability and adaptability of the developed solutions.

Additionally, the present disclosure aims to support the scalability and modularity of the application design. The modular structure of the disclosed system enables developers to easily add or modify application features by selecting additional micro-components. This approach allows for incremental updates and enhancements without disrupting the existing application architecture. As a result, developers can efficiently expand the application's functionality as needed while maintaining structural integrity and consistency.

Moreover, the present disclosure seeks to improve developer productivity by providing a library of pre-built, reusable micro-components. These components are designed to minimize repetitive coding tasks, allowing developers to focus on high-level functionality and customization. By integrating UI elements with functional logic, the system eliminates the need to manually code common features, streamlining the entire development cycle. Consequently, the present disclosure empowers developers to create robust, feature-rich applications efficiently and with reduced error rates.

In one implementation of the present disclosure, the system may provide, via the interactive User Interface (UI), a plurality of reusable micro-components to a user for development of the application. In an embodiment, each of the plurality of reusable micro-components may include a plurality of user interface elements and an associated functional source code. Further, the system may receive, via the UI, a selection of the plurality of reusable micro-components from the user. In an embodiment, the selection may be performed using the drag-drop functionality. Further, the system may integrate the functional source code associated with each of the selected plurality of reusable micro-components to create one or more functional features associated with the application. In an embodiment, the one or more functional features may be created without manual writing of additional source code. Moreover, the system may display the selected plurality of reusable micro-components and the integrated functional source code. This approach enhances the efficiency and flexibility of application development by offering reusable micro-components that integrate user interface (UI) elements and functional source code seamlessly. By providing the drag-and-drop functionality and automating the code integration process, the system not only accelerates development, but also reduces the potential for errors commonly associated with manual coding and integration. Additionally, the system is designed to be platform-agnostic, allowing the developed applications to be deployed across various operating environments without the need for substantial modification. This feature ensures that the applications created using the system maintain consistent performance and functionality regardless of the underlying platform. The system's modularity also supports scalability, enabling developers to add or modify features by selecting the additional micro-components without affecting the existing application structure.

In contrast to traditional development environments, which typically involve manually coding individual application components and integrating the application components with disparate functional source code, the disclosed system offers a streamlined, low-code or no-code approach. The drag-and-drop functionality, combined with reusable micro-component integration, significantly reduces development time and effort. Developers can focus on application-specific customization rather than foundational code construction, making the development process more accessible to users with varying technical expertise.

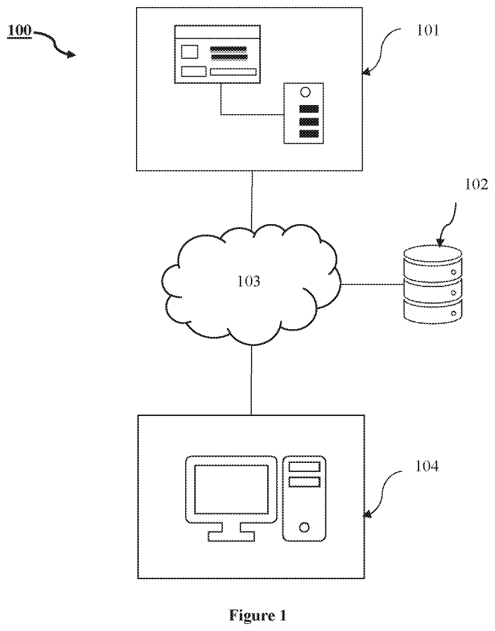

Referring to FIG. 1, illustrates a block diagram (100) showing an overview of various components of the application server (101) configured for application development in accordance with at least one embodiment of the present subject matter. In an embodiment, the system (100) includes an application server (101), a database server (102), a communication network (103), and a user interface framework. The user interface framework is hosted or rendered on the user computing device (104) and serves as the primary medium through which the user interacts with the system (100). The application server (101) is responsible for executing functional units of the reusable micro-components, coordinating with the database server (102) for data storage, and interacting with the user interface framework for visualizing workflows and application components. The drag-and-drop mechanism may be employed for integrating the reusable micro-components that are handled by the application server (101), allowing developers to visually assemble the reusable micro-components from a centralized component library. In an embodiment, the application server (101) may communicate with the database server (102), and the user computing device (104) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In an embodiment, the database server (102) may be responsible for storing and managing a collection of the reusable micro-components and the reusable micro-components associated functional source code. The database server (102) may ensure that these reusable micro-components are stored in a structured manner that allows efficient retrieval and integration during the application development process. When a user selects the plurality of reusable micro-components via the user interface framework, the database server (102) may provide access to the corresponding functional source code, enabling functional source code seamless integration into the application. In an embodiment, the functional source code corresponding to each of the plurality of reusable micro-components is stored in a centralized component library that is dynamically accessed during development of the application. The database server (102) may be designed to perform various database operations, including but not limited to storing, retrieving, indexing, updating, and managing the plurality of reusable micro-components. These operations may ensure that the micro-components are readily available when needed and that the integration process is quick and efficient. Additionally, the database server (102) may maintain a structured and organized repository of the plurality of reusable micro-components, including metadata that may define the plurality of reusable micro-components usage, versioning, and compatibility. This structured storage approach may support rapid data access, reducing latency during component selection and integration. The database server (102) may perform several key operations to ensure the efficient management of the micro-components. Storing may involve saving the plurality of reusable micro-components and the plurality of reusable micro-components associated functional source code into structured databases. In an exemplary embodiment, indexing may involve organizing the micro-components for quick lookup based on attributes such as type, function, or version. In an exemplary embodiment, updating may encompass modifying existing micro-components or adding new versions while maintaining backward compatibility. In an exemplary embodiment, managing may include keeping track of micro-component usage, maintaining logs of interactions, and handling data backup and recovery. These operations may collectively ensure that the reusable micro-components are maintained in a structured, consistent, and accessible manner. In an embodiment, the database server (102) may include hardware configured to perform one or more predetermined operations related to data storage and management. These operations may involve maintaining data integrity, executing complex queries, and supporting concurrent access by multiple users. Moreover, the database server (102) may ensure data consistency when multiple micro-components are combined, preventing conflicts and enabling smooth application assembly. Examples of database operations may include, but are not limited to, storing, retrieving, logging, and managing data. In an embodiment, the database server (102) may be realized using various technologies, including but not limited to Microsoft® SQL Server, Oracle®, IBM DB2®, Microsoft Access®, PostgreSQL®, MySQL®, SQLite®, or distributed database technologies. The choice of technology may vary based on the system's scalability and performance requirements.

A person with ordinary skills in art will understand that the scope of the disclosure is not limited to the database server (102) as a separate entity. In an embodiment, the functionalities of the database server (102) can be integrated into the application server (101) or into the user computing device (104).

In an embodiment, the application server (101) may refer to a computing device or a software framework hosting an application or a software service. In an embodiment, the application server (101) may be implemented to execute procedures such as, but not limited to, programs, routines, or scripts stored in the database server (102) for supporting the hosted application or the software service. In an embodiment, the hosted application or the software service may be configured to perform one or more predetermined operations. The application server (101) may be realized through various types of application servers such as, but are not limited to, a Java application server, a .NET framework application server, a Base application server, a PHP framework application server, or any other application server framework.

In an embodiment, the application server (101) may serve as the central hub for managing and controlling the entire process of application development using reusable micro-components. The application server (101) may be responsible for executing tasks associated with providing, managing, and displaying the user interface (UI), through which users may interact with the system. Further, this interface may allow users to access the centralized library of reusable micro-components and, using the drag-and-drop functionality, select and incorporate these components into the user's application development process. Furthermore, the application server (101) may ensure that once the micro-component is selected, the micro-component is integrated seamlessly into the workflow, providing the necessary functionality without requiring any additional manual coding or customization. The application server (101) may handle a dynamic compilation of the selected components, thereby allowing the application to be rapidly assembled and deployed. The application server (101) may also communicate with other system components, such as the database server (102), to retrieve the required plurality of reusable micro-components and associated functional source code. This communication may ensure that the reusable micro-components are available for immediate use and displayed correctly within the UI. By leveraging a modular and extensible architecture, the application server (101) may facilitate rapid application development while ensuring scalability and flexibility for diverse use cases.

In an embodiment, the application server (101) may be configured to provide, via the interactive user interface (UI), the plurality of reusable micro-components to the user for development of the application. In an embodiment, each of the plurality of reusable micro-components may include the plurality of the user interface elements and the associated functional source code.

In an embodiment, the application server (101) may be configured to receive, via the UI, the selection of the plurality of reusable micro-components from the user. In an embodiment, the selection being performed using the drag-drop functionality. In an embodiment, the application server (101) may be configured to integrate the functional source code associated with each of the selected plurality of reusable micro-components to create the one or more functional features associated with the application. In an embodiment, the one or more functional features being created without the manual writing of additional source code. In an embodiment, the application server (101) may be configured to display the selected plurality of reusable micro-components and the integrated functional source code, via the UI.

In an embodiment, the communication network (103) may correspond to a communication medium through which the application server (101), the database server (102), and the user computing device (104) may communicate with each other. Such communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (103) may either be a dedicated network or a shared network. Further, the communication network (103) may include a variety of network devices, including routers, bridges, servers, computing devices, storage devices, and the like. The communication network (103) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the user computing device (104) may comprise one or more processors (201) and one or more memory (202). The one or more memory may include computer readable instructions that may be executable by one or more processors (201) to perform predetermined operations of the system (100). In an embodiment, the user computing device (104) may present a web user interface to display operations performed by the application server (101). Example web user interfaces presented on the one or more portable devices to display a visualization dashboard which facilitates workflow management through an interactive, drag-and-drop interface without manual coding. Examples of the user computing device (104) may include, but are not limited to, a personal computer, a laptop, a personal digital assistant (PDA), a mobile device, a tablet, or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system provides the reusable micro-components via the interactive UI, and the components are displayed to the user in an intuitive and visually organized manner. The UI enables users to select the desired micro-components using a drag-and-drop functionality, significantly reducing the complexity involved in conventional application development workflows. The reusable micro-components are pre-configured to contain the UI elements such as buttons, input fields, and display panels and the corresponding functional logic such as data processing, API integration, and workflow automation, eliminating the need for developers to manually write or integrate source code. Upon receiving the user's selection of the micro-components, via the UI, the system integrates the functional source code associated with each of the chosen components to form the one or more functional features within the application. This integration process occurs automatically and without manual intervention, thereby enabling the creation of complex application features without the need for custom coding. The seamless integration of UI elements with functional logic ensures that the resulting application components are consistent and error-free, supporting reliable application performance. Once the integration process is complete, the system displays the selected micro-components along with the corresponding integrated functional source code within the UI. This visual presentation enables users to monitor the development process and immediately observe the functional composition of the application. The system's real-time display capability allows for efficient tracking and validation of the implemented features, thereby minimizing debugging and manual verification.

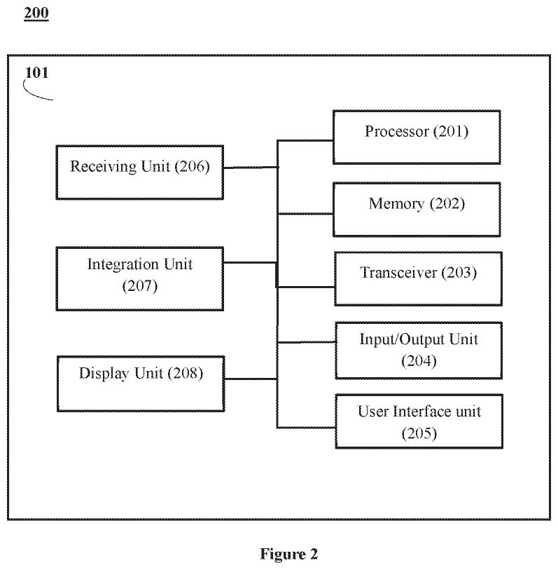

Now referring to FIG. 2, illustrates a block diagram (200) showing an overview of various components of the application server (101) configured for application development in accordance with at least one embodiment of the present subject matter. FIG. 2 is explained in conjunction with elements from FIG. 1. In an embodiment, the application server (101) includes a processor (201), a memory (202), a transceiver (203), an input/output unit (204), a user interface unit (205), a receiving unit (206), an integration unit (207), and a display unit (208). The processor (201) may be communicatively coupled to the memory (202), the transceiver (203), the input/output unit (204), the user interface unit (205), the receiving unit (206), the integration unit (207), and the display unit (208). The transceiver (203) may be communicatively coupled to the communication network (104) of the system (100).

The processor (201) comprises suitable logic, circuitry, interfaces, and/or code that may be configured to execute a set of instructions stored in the memory (202), and may be implemented based on several processor technologies known in the art. The processor (201) works in coordination with the memory (202), the transceiver (203), the input/output unit (204), the user interface unit (205), the receiving unit (206), the integration unit (207), and the display unit (208) for application development. Examples of the processor (201) include, but not limited to, a standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read-only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, serves as a repository for storing data processed, received, and generated by one or more of the programs or the coded instructions. In yet another embodiment, the memory (202) may be managed under a federated structure that enables the adaptability and responsiveness of the application server (101).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (103) of the system (100) for communicating all the information, data, signals, programs, routines or scripts through the communication network (103).

The transceiver (203) may implement one or more known technologies to support wired or wireless communication with the communication network (103). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the user computing devices (104). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (101) to be logically coupled to other user computing devices (104), some of which may be built in. Illustrative components include tablets, mobile phones, wireless devices, etc.

Further, the input/output unit (204) facilitates seamless data exchange between the processor (201) and external user computing devices, such as the user interface framework. It is responsible for managing all input and output operations within the system (100), including receiving user interactions via the interactive User Interface (UI). These interactions may include drag-and-drop selection of reusable micro-components, configuration commands, or data submissions. The input/output unit (204) ensures efficient processing and communication of such inputs, enabling the system to dynamically provide, integrate, and render the selected micro-components. As an intermediary, the input/output unit (204) supports real-time updates and visualization of user-selected functional features, thereby facilitating smooth application development without manual coding. Similarly, the input/output unit (204) ensures that processed results or system notifications are sent back to the user, thereby maintaining a continuous data exchange loop. In an exemplary embodiment, the input/output unit (204) supports various input types, including keyboard inputs, touch gestures, voice commands, and data file uploads, allowing for diverse interaction methods. The output functionality includes displaying processed data, graphical reports, and system alerts, ensuring the user remains informed about ongoing processes. This dual capability of handling both input and output operations makes the input/output unit (204) crucial in maintaining a responsive and interactive system environment.

Further, the user interface (UI) unit (205) may be configured to provide the plurality of reusable micro-components to a user for the development of the application. Each of the plurality of reusable micro-components may include the plurality of user interface elements and associated functional source code. Furthermore, the plurality of reusable micro-components may be designed to facilitate application development by offering pre-built, ready-to-use elements that significantly reduce the need for custom coding. By incorporating these reusable components, users may rapidly assemble complex applications with minimal technical expertise. The system allows users to easily access and integrate these components through an intuitive graphical interface, promoting efficiency and consistency in application development.

In an exemplary embodiment, the plurality of reusable micro-components may include at least one of a UI layer, a functional source layer, one or more bindings, and one or more styles. The UI may define the visual representation of the component, including the layout, appearance, and user interaction elements. In an exemplary embodiment, the functional source layer may contain the at least one of, core logic, data processing routines, event-handling mechanisms, or a combination of the same, that enable the micro-component to perform its intended functions. In an exemplary embodiment, the one or more bindings may link the UI layer with the functional source layer, allowing dynamic data flow and interaction. Furthermore, the one or more styles may define the aesthetic aspects, including color schemes, fonts, and spacing, to maintain visual consistency. Each of the plurality of reusable micro-components is designed to be agnostic to a development platform or a programming language, thereby ensuring compatibility across diverse development environments. This platform-agnostic nature is particularly beneficial in scenarios where the application may be deployed on multiple platforms, such as web, mobile, or desktop.

Furthermore, the plurality of reusable micro-components may correspond to a modular software that encapsulates the plurality of the user interface elements along with the associated functional source code. Each reusable micro-component may be designed to perform a specific function or represent a self-contained unit of functionality within the application. For example, a login micro-component may include a text box for username, a password input field, and a submit button, along with the logic required to authenticate the user and manage login events. The associated functional source code may provide at least one of logic, event handling, data processing, and connectivity required for the plurality of user interface elements to operate coherently, thereby enhancing modularity and maintainability. This modular design allows for the reuse of micro-components across various applications and promotes streamlined development practices.

In an exemplary embodiment, the plurality of user interface elements may include a radio button, a check box button, a login button, a text box, a drop-down menu list, a submit button, a file upload button, sliders, icons, labels, or a combination of the same. These elements support a wide range of user interactions and application functionalities. For example, radio buttons and check box buttons may be used for selecting options, login buttons may trigger authentication processes, text boxes may capture user input, and sliders may adjust settings dynamically. By providing a comprehensive set of elements, the system empowers users to create sophisticated user interfaces without needing to write custom code for each component.

Further, the user interface unit (205) may be configured to support the development of applications in a low-code development platform, a no-code development platform, or any other development platform. This flexibility ensures that users with varying levels of technical expertise can effectively utilize the system for application creation. By implementing the drag-and-drop functionality of reusable micro-components, the system reduces the learning curve associated with traditional software development. In low-code environments, users can customize the behavior and appearance of components through simplified configuration interfaces. In no-code environments, users can directly implement functionalities by selecting and arranging pre-built components, enabling rapid prototyping and deployment.

Moreover, the user interface unit (205) may include a first portion and a second portion within the interactive UI. The first portion may display the plurality of reusable micro-components available for selection, while the second portion may display the selected plurality of reusable micro-components arranged according to the user's preferences. This dual-pane structure facilitates intuitive drag-and-drop operations, allowing users to visually compose their application layout. As the users select and position the one or more micro-components, the second portion updates in real-time, providing immediate feedback on the assembled interface. This real-time visualization helps users understand how their application will look and function, thereby promoting a more efficient development workflow. Additionally, the user interface unit (205) may further support a voice-based command interface within the interactive UI, enabling users to define application logic or select the plurality of reusable micro-components using natural language input. This voice command functionality may allow users to issue commands such as “Add a login form” or “Insert a text box” without navigating through menus. Additionally, users may specify functional behavior using voice, such as “Connect the submit button to the authentication API.” By interpreting natural language commands, the system enhances accessibility, allowing users with limited programming knowledge to perform complex configuration tasks seamlessly. Furthermore, the system may also recognize textual descriptions, making it suitable for environments where voice input is not feasible.

The receiving unit (206) may be configured to receive, via the UI, a selection of the plurality of reusable micro-components from the user. The selection may be performed using the drag-and-drop functionality, allowing users to intuitively choose components from the library and position them within the application development interface. This interaction may streamline the development process by offering a visual method of selection and arrangement, reducing the need for manual coding.

The receiving unit (206) may further facilitate the drag-and-drop functionality, allowing users to visually select and reposition the plurality of reusable micro-components within the UI during the application development process. This capability may enable users to rearrange the components efficiently, adapt layouts dynamically, and create customized application interfaces without requiring the backend coding changes or the manual integration. By abstracting the underlying code complexity, this functionality may significantly enhance usability, making the development process more accessible to non-technical users.

The receiving unit (206) may additionally incorporate a rule engine within the drag-and-drop functionality, designed to restrict invalid selections of the plurality of reusable micro-components. The rule engine may automatically detect and prevent incompatible component combinations, thereby ensuring that only valid configurations are allowed. Furthermore, the rule engine may suggest contextual integrations based on pre-defined development patterns, guiding users toward optimal component arrangements and encouraging best practices. This intelligent guidance may help users avoid errors and maintain consistency in application design.

The integration unit (207) may be configured to integrate the functional source code associated with each of the selected plurality of reusable micro-components to create one or more functional features associated with the application. The integration may occur seamlessly, with the system handling all connections and dependencies without requiring the manual writing of additional source code. This automatic integration process allows for rapid development of the application, as the one or more users can assemble and activate complex functionalities using pre-existing, reusable components.

The integration unit (207) may be further configured to identify one or more errors in the integrated functional features by compiling the integrated functional source code associated with each of the selected plurality of reusable micro-components. This process ensures that any issues, such as syntax errors or logical inconsistencies, are detected early, allowing developers to address them promptly. The system may notify users of errors in real-time, ensuring smooth application development.

The integration unit (207) may utilize functional source code to provide the one or more functional features to the associated plurality of reusable micro-components. The functional source code corresponding to each of the plurality of reusable micro-components may be stored in a centralized component library, which is dynamically accessed during the development of the application. This centralized storage enables efficient management of reusable components and ensures that the latest versions of components are always available for integration, reducing redundancy and improving system scalability.

The integration unit (207) may create the one or more functional features that correspond to functionalities such as a login feature, validation feature, search feature, calendar feature, appointment scheduler, payment feature, or a combination of the same. These features may be automatically integrated into the application based on the selected micro-components, allowing users to leverage common functionalities without having to manually implement them from scratch. This flexibility allows for the creation of complex applications with minimal effort.

The integration unit (207) may further include a detailed integration process, which includes receiving metadata for each of the selected plurality of reusable micro-components. In an exemplary embodiment, the metadata may contain information such as a unique identifier for each micro-component, definitions of input and output parameters, component state variables, event-handler mappings, inter-component dependencies, rendering instructions, and styling attributes. Using this metadata, the system may automatically add, in real-time, one or more lines of source code to connect the functional source code of each selected micro-component. This process allows for rapid application development, reducing the need for manual coding. Additionally, the integration unit (207) may update a master source code of the application with the integrated functional source code in real-time, reflecting user modifications to the selected micro-components. This real-time integration ensures that the application is always up-to-date, maintaining synchronization between the UI and the underlying functionality.

The integration unit (207) may also be configured to perform runtime configuration and dependency resolution of the integrated functional source code. This means that the system may analyze and resolve any interdependencies or conflicts between the micro-components, ensuring that each component functions cohesively within the application. This runtime management allows for dynamic adjustments based on user interactions and ensures smooth performance throughout the development lifecycle.

The integration unit (207) may include functionality for maintaining a version history of the integrated functional source code. In an embodiment, this version history allows the users to rollback or restore previously generated application states. By keeping track of changes, the system enables the users to experiment with different configurations and features without the fear of losing previous work, fostering a more flexible and iterative development process.

The integration unit (207) may also be configured to perform automated testing of the integrated functional source code. Using pre-defined test templates corresponding to the selected plurality of reusable micro-components, the system may automatically execute tests to ensure the integrated source code performs as expected. Automated testing helps identify and resolve bugs or performance issues early in the development process, ensuring the final application meets the desired standards.

The integration unit (207) may allow real-time collaboration between multiple users for simultaneous development of the application via the interactive UI. However, the changes made by one user may be reflected in real-time to other collaborating users, enabling teams to work together efficiently on the same project. This collaboration feature enhances productivity and ensures that all team members are aligned, regardless of their physical location.

The integration unit (207) may be designed to detect one or more conflicting dependencies among the selected plurality of reusable micro-components. When such conflicts are detected, the integration unit (207) may automatically resolve the conflicts by updating the integrated functional source code based on semantic source code analysis. This ensures that dependencies between components are properly managed, and the application functions as intended without requiring manual intervention from the user.

The display unit (208) may be configured to display the selected plurality of reusable micro-components and the integrated functional source code to the user. The display may provide a clear, organized view of the application development process, visually representing the components selected by the user and the corresponding integrated source code. This enables users to track their progress, inspect the functional structure of their application, and make adjustments as needed, all within a cohesive and easily navigable interface.

The display unit (208) may support the deployment of the application developed using the selected plurality of reusable micro-components across a variety of platforms, including web, mobile, and desktop environments, without requiring separate builds for each platform. This cross-platform compatibility ensures that the application works seamlessly across different devices and operating systems, saving time and effort by eliminating the need for multiple platform-specific builds.

The display unit (208) may also incorporate a real-time analysis feature. In an embodiment, the display unit (208) may be configured to analyze in real-time the selection of the plurality of reusable micro-components and the sequence of the selection during development of the application. Based on this analysis, the display unit (208) may suggest the one or more additional reusable micro-components to the user. This suggestion may be powered by a machine learning model trained on historical usage data, which includes previous application builds and user interaction logs. By leveraging this data, the system may provide personalized recommendations, improving the efficiency of the application development process.

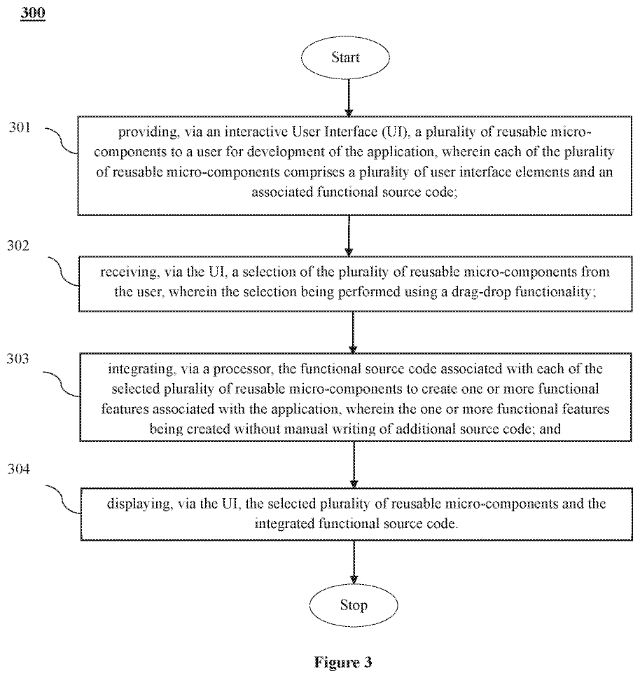

Now referring to FIG. 3, illustrates a flowchart describing a method (300) for application development, in accordance with at least one embodiment of the present subject matter. The flowchart is described in conjunction with FIG. 1 and FIG. 2. The method (300) starts at step (301) and proceeds to step (304).

In operation, the method (300) may involve a variety of steps, executed by the processor (201), for developing the application.

At step (301), the method involves providing, via the interactive User Interface (UI), the plurality of reusable micro-components to the user for development of the application. In an embodiment, each of the plurality of reusable micro-components may include the plurality of user interface elements and the associated functional source code.

At step (302), the method involves receiving, via the UI, the selection of the plurality of reusable micro-components from the user. In an embodiment, the selection may be performed using the drag-drop functionality.

At step (303), the method involves integrating the functional source code associated with each of the selected plurality of reusable micro-components to create the one or more functional features associated with the application. In an embodiment, the one or more functional features being created without the manual writing of additional source code.

At step (304), the method involves displaying, via the UI, the selected plurality of reusable micro-components and the integrated functional source code.

Let us delve into a detailed example of the present disclosure.

### Working Example 1: Customer Management Application

Consider a user accessing an application development platform to create a customer management system. The platform offers various pre-built, reusable micro-components that are designed to handle specific tasks without the need for additional coding or programming knowledge.

### Step 1: Selecting the “Customer Registration” Micro-Component

The user logs into the platform and is presented with an interactive user interface (UI) that displays a range of available reusable micro-components. These micro-components include different aspects of the application, such as customer management, order processing, and reporting.
The user selects the “Customer Registration” micro-component from the UI. This component contains a predefined set of user interface elements and functional source code, including:
   Input fields for the customer's name, email address, phone number, and physical address.
   Submit button that, when clicked, triggers an event to store the entered data.
   Validation rules for checking that the required fields are filled out correctly (e.g., proper email format, phone number).
   Event handling code for submitting the form and saving data to the backend (although the user doesn't need to manually write any code).
As the user drags the micro-component onto the development canvas, the system instantly integrates the associated functionality, including real-time updates of the UI on the screen.

### Step 2: Adding the “Profile Management” Micro-Component

After adding the customer registration feature, the user decides to add a “Profile Management” micro-component, allowing users to update their information.
The user selects the “Profile Management” micro-component from the UI and drags it onto the canvas.
The platform automatically integrates this micro-component into the application, ensuring the following functionalities:
   Editable fields for customer details such as address, phone number, and email.
   Save/Update button to save the modified data.
   Event handling for saving the new data into the system.
   Validation to ensure that only valid data is submitted.
   The system ensures that both the “Customer Registration” and “Profile Management” micro-components work together cohesively. The platform handles any backend logic necessary for these micro-components to interact, such as ensuring that a user's profile information is updated when changes are made.

### Step 3: Real-Time Preview and Deployment

Throughout the development process, the user is able to preview the application in real-time. Any changes made to the application layout or functionality are instantly displayed in the preview mode, giving the user a live view of how the app will appear and behave once deployed.
The system supports deployment to multiple platforms (e.g., web, desktop, and mobile) without needing separate builds for each. The user can see how the app looks and functions on different devices, and the platform automatically handles any necessary adjustments for different screen sizes and devices.

### Step 4: Final Modifications and Exporting

Once the user is satisfied with the layout and functionality, the user can finalize the application. The system continuously saves the user's progress and maintains a version history, allowing the user to roll back to a previous state if needed.
The user can export the final version of the application, which will be compatible with web, mobile, and desktop environments.

### Working Example 2

Let us delve into another detailed example of the present disclosure.

Consider a digital application development platform designed to empower users to create functional applications without requiring programming skills. For example, a user accessing the platform is presented with a plurality of reusable micro-components, such as a “Contact Form.” The user may easily drag and drop this micro-component into the application canvas, where the system automatically retrieves and displays its ready-to-use functionalities, including text boxes, radio buttons, and a submit button. If the user wishes to add a “Feedback Form,” the user may also drag and drop that micro-component, and the system seamlessly integrates both functionalities.

This platform supports various devices and operating systems, ensuring a low-code, no-code environment that allows users to efficiently develop and preview their applications in real-time, streamlining the application development process significantly.

Let's envision a user-friendly application development platform named “XYZ” designed to enable users to create functional applications effortlessly without requiring any coding knowledge.

Imagine a user who logs into “XYZ” platform to develop an application for collecting customer feedback. Upon accessing the platform, the user is greeted with the plurality of reusable micro-components displayed on the user interface (UI). The user decides to drag and drop a “Contact Form” micro-component onto an application canvas. As the user performs this action, the “XYZ” platform processor retrieves the plurality of reusable micro-components along with the functional source code associated with the “Contact Form,” including text boxes for the user input, radio buttons for feedback options, and a submit button. This functionality is displayed in real-time on the canvas, allowing the user to see exactly how the micro-component will appear in the final application.

After successfully adding the “Contact Form,” the user wants to incorporate a “Feedback Form” to gather additional insights. The user easily drags the “Feedback Form” micro-component onto the canvas as well. “XYZ” automatically integrates the functionalities of both micro-components, ensuring they work together seamlessly without any backend coding changes. Throughout the development process, “XYZ” supports various devices and platforms, ensuring that the user may access the application from a desktop or a mobile device. Once the user is satisfied with the layout and functionalities, the user may preview the application in real-time to verify that everything operates as intended. This intuitive drag-and-drop mechanism significantly streamlines the application development process, enabling users to focus on design and user experience rather than technical complexities.

### Working Example 3

Let us delve into another detailed example of the present disclosure.

Consider a user-centric workflow management platform called “LMK” designed to empower users to organize and automate their tasks efficiently, requiring no prior technical expertise.

Imagine a user who logs into “LMK” to establish a workflow for tracking project progress. Upon entering the platform, the user is welcomed by a dashboard showcasing various plurality of reusable workflow templates displayed on the user interface (UI). The user opts to drag and drop a “Task Assignment” micro-component onto the workflow canvas. As the user performs this action, the “LMK” processor retrieves the associated functionalities of the “Task Assignment” micro-component, including options to assign tasks to team members, set deadlines, and attach relevant documents. This functionality is rendered in real-time on the canvas, allowing the user to visualize how the micro-component will operate within the complete workflow.

After successfully incorporating the “Task Assignment” micro-component, the user wishes to add a “Progress Tracker” to monitor the status of tasks. The user effortlessly drags the “Progress Tracker” micro-component onto the canvas as well. “LMK” automatically links the functionalities of both micro-components, ensuring they function cohesively without requiring any backend coding adjustments.

Throughout the workflow creation process, “LMK” is compatible with various devices and platforms, enabling the user to access the workflow from both desktop and mobile devices. Once the user is satisfied with the arrangement and functionalities, they can preview the workflow in real-time to confirm that everything works as intended. This intuitive drag-and-drop functionality significantly simplifies the workflow creation process, allowing users to concentrate on efficiency and productivity rather than technical difficulties.

A person skilled in the art will understand that the scope of the disclosure is not limited to scenarios based on the aforementioned factors and using the aforementioned techniques and that the examples provided do not limit the scope of the disclosure.

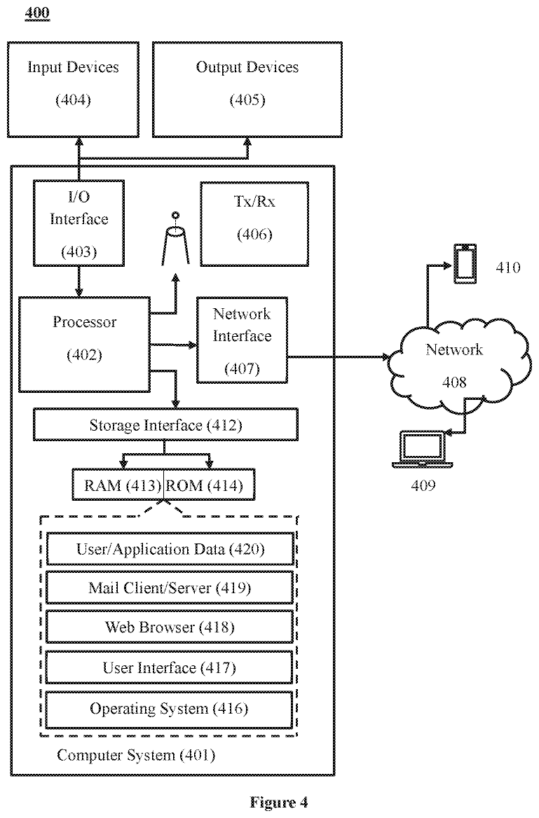

Now referring to FIG. 4, illustrates a block diagram (400) of an exemplary computer system (401) for implementing embodiments consistent with the present disclosure. Variations of computer system (401) may be used for application development. The computer system (401) may comprise a central processing unit (“CPU” or “processor”) (402). The processor (402) may comprise at least one data processor for executing program components for executing user-or system-generated requests. A user may include a person, a person using a device such as those included in this disclosure, or such a device itself. Additionally, the processor (402) may include specialized processing units such as integrated system (bus) controllers, memory management control units, floating point units, graphics processing units, digital signal processing units, or the like. In various implementations the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed in communication with one or more input/output (I/O) devices via I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user's smartphone, tablet, cell phone, laptop, printer, fax machine, video display (e.g., cathode ray tube (CRT), liquid crystal display (LCD), light-emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB 8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface, coupled to the processor may be configured to facilitate communication between the system and one or more external devices or networks. The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems'Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (520) may be a mail viewing application, such as Apple Mail, Microsoft Entourage, Microsoft Outlook, or Mozilla Thunderbird.

In some embodiments, the computer system (401) may store user/application data (420), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

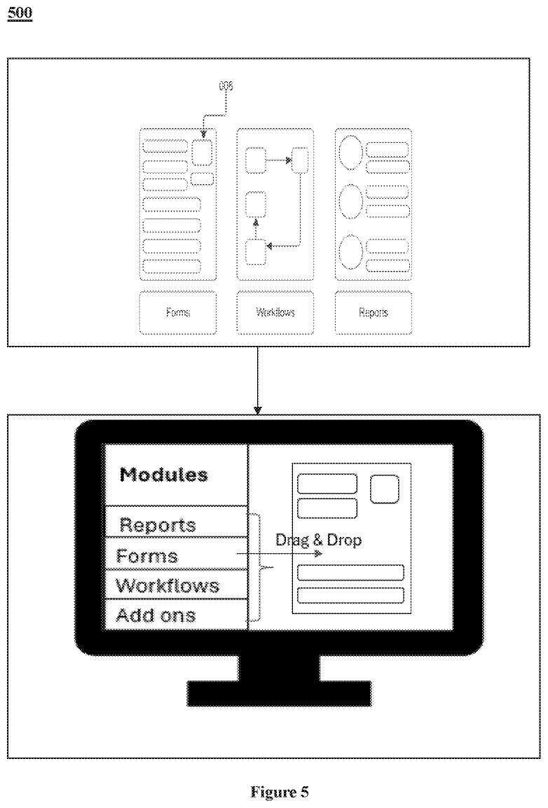

Now referring to FIG. 5, a block diagram (500) showing an overview of exemplary user interface providing the one or more functional features for application development, in accordance with at least one embodiment of present subject matter. In an exemplary embodiment, the user interface presents an organized collection of the plurality of reusable components prominently displayed on a desktop screen (501). This interface serves as an interactive workspace including the plurality of reusable components, encompassing various forms, workflows, and reports, that are readily accessible to users. The disclosed system promotes ease of use through a sophisticated drag-and-drop mechanism, enabling users to intuitively select any desired reusable component and reposition the component within the application canvas with minimal effort.

In some embodiments, upon selecting the reusable component, users may not only move the selected component but also visualize its inherent functionalities, which are displayed alongside the component itself. This feature ensures that users have immediate insight into what each component can accomplish, eliminating any ambiguity regarding its capabilities. For example, a form component might reveal fields for data entry, while a workflow component may showcase the steps involved in a process. This transparency fosters a better understanding of how each component fits within the broader application context.

Furthermore, as users drag and drop components onto the interface, the system automatically integrates these functionalities into the user's development environment. This integration process is designed to be seamless, meaning that users do not have to engage in complex backend configurations or coding to make the reusable components operational. Instead, the system automatically aligns the selected component's functionalities with the existing application architecture, ensuring that data flows smoothly and processes execute as intended.

Various embodiments of the disclosure provide a non-transitory computer-readable medium and/or storage medium, and/or a non-transitory machine-readable medium and/or storage medium having stored thereon a set of computer-executable instructions when executed by the processor (201) may cause the processor (201) to perform various steps. Further, the steps may include providing (301) the plurality of reusable micro-components to the user for development of the application. In an embodiment, each of the plurality of reusable micro-components may include the plurality of user interface elements and an associated functional source code. Furthermore, the steps may include receiving (302) the selection of the plurality of reusable micro-components from the user. In an embodiment, the selection being performed using the drag-drop functionality. Furthermore, the steps may involve integrating (303) the functional source code associated with each of the selected plurality of reusable micro-components to create one or more functional features associated with the application. In an embodiment, the one or more functional features being created without the manual writing of additional source code. Moreover, the steps may involve displaying (304) the selected plurality of reusable micro-components and the integrated functional source code.

Various embodiments of the disclosure encompass numerous advantages including the system for application development. The disclosed system and method have several technical advantages, but not limited to the following:
User-Friendly Interface: The system employs a drag-and-drop mechanism within its user interface (UI), allowing users regardless of technical expertise to easily select and position pre-built functional or reusable components. This contrasts with prior systems that often require extensive coding knowledge for micro-component integration, thereby lowering the barrier to entry for users.
Pre-built Functional Reusable Micro-Components: The use of non-customizable, ready-to-use functional micro-components significantly accelerates the application development process. Unlike prior art, where developers frequently had to create and customize components from scratch, this system provides immediate access to fully functional components, thereby reducing development time and effort.
Seamless Integration: The functionality of multiple pre-built functional components can be integrated without manual intervention, unlike prior systems that often necessitated extensive backend coding or complex configuration settings. This automated integration reduces the potential for errors and simplifies the development workflow.
Platform and Language Agnostic: The reusable micro-components are designed to be both platform-agnostic and programming language-agnostic, enabling their use across various environments and tech stacks. This flexibility allows organizations to implement the system without being locked into specific technologies, a limitation present in many traditional application development platforms.
Support for Low-Code/No-Code Development: By supporting low-code and no-code platforms, the invention caters to a broader audience, including business analysts and non-technical stakeholders. Prior systems typically required significant programming skills, which limited participation from diverse teams in the development process.
Increased Productivity: By reducing the need for coding and extensive configuration, the system enables faster iteration and deployment of applications. Users can focus on functional requirements rather than technical constraints, enhancing overall productivity compared to traditional application development methods.
Scalability: The architecture of the system allows for easy addition of new reusable micro-components without disrupting existing functionalities. This contrasts with earlier systems that often-required significant rework to accommodate new features, thus improving scalability and adaptability.

In summary, the disclosed system (100) and method (300) for application development effectively address the challenges of complex coding and lengthy development times by providing an intuitive, interactive drag-and-drop interface. Users, regardless of technical proficiency, can easily select and position the reusable micro-components that consist of both user interface elements and functional source code. This streamlines the development process by automatically integrating the selected components to create functional features, without requiring manual coding. The system's platform-agnostic nature and its support for low-code/no-code environments further enhance accessibility and collaboration across diverse teams, driving productivity and accelerating time-to-market. Additionally, the system provides features like real-time error detection, version history, automated testing, and dependency resolution, ensuring a seamless and error-free development experience.

The claimed invention incorporates tangible components, processes, and functionalities that work together to improve the application development process. The system integrates the processors (201), the memory (202), the user interfaces, and the reusable micro-components in the platform-agnostic manner to facilitate the creation of applications. It empowers users to develop applications rapidly by leveraging reusable micro-components, streamlining workflows, and reducing manual coding efforts.

Furthermore, the present disclosure represents a non-trivial combination of existing technologies and methodologies, offering a technical solution to a significant problem in software development. The present disclosure and the claimed limitations provide a unified, user-friendly system for application development particularly with features like drag-and-drop functionality and real-time source code integration which demonstrates a substantial advancement in the field of low-code/no-code platforms.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, functional units, and reusable micro-components have been illustrated and explained to serve as examples and should not be considered limiting in any manner. It will be further appreciated that the variants of the above disclosed system elements, components, and other features and functions, or alternatives thereof, may be combined to create other different systems or applications.

Those skilled in the art will appreciate that any of the aforementioned steps and/or system units and micro-components may be suitably replaced, reordered, or removed, and additional steps and/or system components may be inserted, depending on the needs of a particular application. In addition, the systems of the aforementioned embodiments may be implemented using a wide variety of suitable processes and system components, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

We claim:

1. A system for application development, the system comprises:
a processor;
a memory communicatively coupled with the processor, wherein the memory is configured to store one or more executable instructions that, when executed by the processor, cause the processor to:
provide, via an interactive User Interface (UI), a plurality of reusable micro-components to a user for development of the application, wherein each of the plurality of reusable micro-components comprises a plurality of user interface elements and an associated functional source code;
receive, via the UI, a selection of the plurality of reusable micro-components from the user, wherein the selection being performed using a drag-drop functionality;
integrate the functional source code associated with each of the selected plurality of reusable micro-components to create one or more functional features associated with the application, wherein the one or more functional features being created without manual writing of additional source code; and
display, via the UI, the selected plurality of reusable micro-components and the integrated functional source code.

2. The system as claimed in claim 1, wherein the plurality of reusable micro-components comprises a UI layer, a functional source layer, one or more bindings, and one or more styles, and each of the plurality of reusable micro-components is agnostic to a development platform or a programming language.

3. The system as claimed in claim 1, wherein each of the plurality of reusable micro-components corresponds to a modular software that encapsulate the plurality of user interface elements along with the plurality of reusable micro-components associated functional source code and each of the plurality of reusable micro-components is designed to perform a specific function or represent a self-contained unit of functionality within the application, and wherein each of the associated functional source code provides at least one of logic, event handling, data processing, and connectivity required for the plurality of user interface elements to operate coherently.

4. The system as claimed in claim 1, wherein the plurality of user interface elements comprises a radio button, a check box button, a login button, a text box, a drop down menu list, submit button, file upload button, sliders, icons, labels, or a combination thereof.

5. The system as claimed in claim 1, wherein the plurality of user interface elements being used for development of the application in a low code development platform, no-code development platform or any other development platform.

6. The system as claimed in claim 1, wherein the processor is configured to identify one or more errors in the one or more functional features by compiling the integrated functional source code associated with each of the selected plurality of reusable micro-components.

7. The system as claimed in claim 1, wherein the UI comprises a first portion, a second portion, wherein the plurality of reusable micro-components being displayed in a first portion, wherein the selected plurality of reusable micro-components being displayed in a second portion.

8. The system as claimed in claim 1, wherein the functional source code provides the one or more functional features to the associated plurality of reusable micro-components, wherein the functional source code corresponding to each of the plurality of reusable micro-components is stored in a centralized component library that is dynamically accessed during development of the application.

9. The system as claimed in claim 1, wherein the one or more functional features corresponds to one of: login feature, validation feature, search feature, calendar feature, appointment scheduler, payment feature, or a combination thereof.

10. The system as claimed in claim 1, wherein integrating comprises:
receive metadata for each of the selected plurality of reusable micro-components, wherein the metadata comprises a unique identifier of the micro-component, a definition of input and output parameters, component state variables, event-handler mappings, inter-component dependencies, rendering instructions, and styling attributes associated with the reusable micro-component;
automatically add in real-time one or more lines of source code based on the metadata to connect each of the functional source code associated with each of the selected plurality of reusable micro-components, wherein the integrating provides rapid development of the application without manual addition of source code by the user,
update a master source code of the application with the integrated functional source code in real-time based on user modifications to the selected plurality of reusable micro-components; and
perform runtime configuration and dependency resolution of the integrated functional source code.

11. The system as claimed in claim 1, wherein the drag-drop functionality allows the user to visually select and reposition the plurality of reusable micro-components within the UI during development of the application, without requiring backend coding changes or manual integration.

12. The system as claimed in claim 1, wherein the application developed using the selected plurality of reusable micro-components is deployable across a plurality of platforms comprising web, mobile, and desktop environments, without requiring separate builds for each of the plurality of platforms.

13. The system as claimed in claim 1, wherein the processor is configured to maintain a version history of the integrated functional source code, enabling rollback or restoration of previously generated application states.

14. The system as claimed in claim 1, wherein the drag-and-drop functionality comprises a rule engine that restricts invalid selections of the plurality of reusable micro-components and suggests contextual integrations based on pre-defined development patterns.

15. The system as claimed in claim 1, wherein the processor is configured to perform automated testing of the integrated functional source code using pre-defined test templates corresponding to the selected plurality of reusable micro-components.

16. The system as claimed in claim 1, wherein the processor is configured to allow real-time collaboration between a plurality of users for simultaneous development of the application via the interactive UI, wherein changes made by one user are reflected in real time to other collaborating users.

17. The system as claimed in claim 1, wherein the processor is configured to:
detect one or more conflicting dependencies among selected plurality of reusable micro-components; and
automatically resolve the one or more conflicting dependencies by updating the integrated functional source code based on semantic source code analysis.

18. The system as claimed in claim 1, wherein the interactive UI corresponds to a voice-based command interface to provide natural language input to allow the user to define application logic or select the plurality of reusable micro-components using voice commands or textual descriptions.

19. The system as claimed in claim 1, wherein the processor is further configured to:
analyze in real-time the selection of the plurality of reusable micro-components and the sequence of the selection during development of the application; and
suggest one or more additional reusable micro-components based on the analysis using a machine learning model trained on historical usage data, wherein the historical usage data comprises previous application builds and user interaction logs.

20. A method for application development, the method comprising:
providing, via an interactive User Interface (UI), a plurality of reusable micro-components to a user for development of the application, wherein each of the plurality of reusable micro-components comprises a plurality of user interface elements and an associated functional source code;
receiving, via the UI, a selection of the plurality of reusable micro-components from the user, wherein the selection being performed using a drag-drop functionality;
integrating, via a processor, the functional source code associated with each of the selected plurality of reusable micro-components to create one or more functional features associated with the application, wherein the one or more functional features being created without manual writing of additional source code; and
displaying, via the UI, the selected plurality of reusable micro-components and the integrated functional source code.

21. A non-transitory computer-readable storage medium having stored thereon a set of computer-executable instructions that, when executed by a processor, cause the processor to perform the steps of:
providing a plurality of reusable micro-components to a user for development of the application, wherein each of the plurality of reusable micro-components comprises a plurality of user interface elements and an associated functional source code;
receiving the selection of the plurality of reusable micro-components from the user, wherein the selection being performed using a drag-drop functionality;
integrating the functional source code associated with each of the selected plurality of reusable micro-components to create one or more functional features associated with the application, wherein the one or more functional features being created without manual writing of additional source code; and
displaying the selected plurality of reusable micro-components and the integrated functional source code.
